(19) United States
(12) Patent Application Publication
(10) Pub. No.: US 2009/0215538 A1
(43) Pub. Date: Aug. 27, 2009

(54) Method for dynamically synchronizing computer network latency

(76) Inventor: Samuel Jew, Cupertino, CA (US)

Correspondence Address: Samuel Jew, 10109 Oakleaf Place, Cupertino, CA, 95014, US

(21) Appl. No.: 12/070,995

(22) Filed: Feb. 22, 2008

(51) Int. Cl. G06F 17/00

(52) U.S. Cl. 463/42

(57) ABSTRACT

A software method for synchronizing the output of data communications across several output devices, despite geographical distance and/or latency, allowing for the data stream to be dynamically-altered in real time and providing for instant and seamless echoing of local input.

Media selections for play back may be chosen in real-time by any number of operators and combined in real-time to create a meta-media effect of synchronistic and coherent real-time collaboration.

Operator input causes signal transfers to be sent to remote computer(s), which causes each computer to play transition frames, with the amount played depending on the latency from the source so that all finish simultaneously.

The result is synchronous display to a distributed audience of a media stream that anyone can affect in real-time. This system enables mass-scale collaboration for highly complex systems such as online virtual reality applications, and for less complex phenomena such as radio and television.

### CROSS REFERENCE TO RELATED APPLICATION

This application claims the benefit of Provisional Patent Application under the same title filed in February 2007 by the present inventor, which is incorporated by reference.

### BACKGROUND

1. Field of Invention

This invention is in the field of data communications networks.

2. Prior Art

Latency has been a fact of electronic communications since the days of the telegraph. However it's not something that's been widely recognized as a problem to be dealt with until the advent of online gaming, due to the goal of synchronizing the experience of multiple humans who each can alter a system in real-time having this technical barrier. The solutions to the problem of latency in online gaming have been varied. Of the solutions in general operation, the two main techniques appear to involve prediction (iterating a number of steps after the receipt of packets to compensate for latency) and transmitting the data state of the server to the clients periodically to resolve inconsistencies after the fact.

As early as May of 2001, it came to my attention that Illusive Entertainment of Los Angeles, Calif., was very interested in pursuing an online fighting game, which would be an entirely new genre if pulled off, but lacking the requisite technical skills, did not consider potential technical barriers to implementation. The problem, according to a network programmer at Valve (of Counterstrike fame and hence, one of the foremost experts in real time online computer games) during a speech given at the 2001 computer graphics industry conference Siggraph, I attended along with Avi Kessner, (who eventually came up with his own, different latency-compensation scheme) the first technique is extremely useful and works to great effect in games of the first-person shooter genre, where the latency is masked by the fact that even in real life, bullets take a certain amount of time to reach the enemy and the latency happens to be useful for approximating that. However, melee games, including and especially fighting games don't work very well on an online medium because on the one hand, the player wants an immediate response to his input, but on the other, when he throws a punch, he thinks he's already hit his opponent by the time his opponent is even aware a punch was thrown! A similar problem exists with regards to movement and the industry tends to regard the problem as somewhat intractable if they even address it. This is evidenced by their failure to give us a compelling online fighting game thus far despite an abundance of market potential that they recognize but will not openly acknowledge.

That speech was the inspiration for this invention.

There have been several online fighters, but the universal complaint has been about the latency. According to a programmer at Ubisoft in Shanghai, Mark Wang, latency is the number one problem affecting online games today (or was when I spoke with him in 2006). As far as I know, the only online game to address this issue is Iron Phoenix, developed by a company in Taiwan and being published by Sammy Studios, which supposedly has some kind of latency compensation scheme. However, in addition to the announcement being made after I came up with my invention, the method used has not been made public knowledge and from all appearances, seems to be protected by trade secret. No one has said how tolerable the latency in that game is so far as I can tell. In an interview with the trade press, the Sammy representative said the programmers wouldn't even tell him what the technique was! Suffice to say, because they are not willing to reveal their methodology, we have no way of knowing how it compares to what I describe in this patent.

Other attempts at online fighters have generally been 2-D and not held to commercial quality standards. There have been various free Flash games, but because of their being free, it is irrelevant whether they synchronize and it is unlikely that they do. Of attempts at commercial quality online fighters, none has really succeeded in a way that offline multiplayer PvP fighters such as Tekken and Soul Calibur have and generally, this has been attributed to problems with latency. Consequently, the industry standard is to approximate fighting in a kind of turn-based system, perhaps with a count-down timer, similar to the Final Fantasy series. Most online games today with melee combat are fantasy-based RPGs where no immediate reaction is assumed to take place and turn-based combat is the norm.

A number of online games today have information sequences that display a wind-up pose. However this is extremely exaggerated and is more suited to turn-based than online combat. The first game I saw to do this was the Lineage II, which brought this feature out after I discussed it with one of their producers after he signed an NDA with my former company.

A search at http://www.uspto.gov for real time and online in patent applications returned 377 hits, none of which have anything to do with this invention.

Synchronization of music and images in a digital multimedia device system turns out to have nothing to do with what is claimed here. Rather it synchronizes audio and video (i.e. lip movement matches audio) and doesn't deal with the problem of latency in primarily online applications or compensating for it, unlike the central core of what is claimed here.

Other searches for latency, media etc. generated too many results to sift through fully, but none of which appeared to resemble what is claimed here or even have anything remotely to do with it. My reliance on the originality of this invention has less to do with a thorough patent search and more to do with the fact that no one in the industry appears to have the remotest clue how to proceed with an online fighter. If it were already done, they would have already done so.

My idea was that by adding additional frames of information sequence, (wind-up poses/transition information sequences) it should be possible to buffer the poses. I had the idea to do it using interpolation, since I was already familiar with using interpolation in character information sequence and by adding transition information sequences and interpolating from the current pose to the first frame of the new information sequence, it would be possible to immediately react to a change in state, while buffering the time taken needed for the packets to reach all remote computers and queue up the move to be done in a believable and therefore psychologically-acceptable way that buffers the information sequences seamlessly. This would achieve the dual necessary effects mentioned in the SIGGRAPH lecture of immediate user feedback and giving the remote opponent sufficient time to react.

By varying the length of the transition information sequences (achievable by interpolating over a different number of frames), it is possible to make it so they all conclude at the same time, allowing the main information sequences to be played simultaneously and synchronously on multiple remote computers, making latency and therefore distance a non-issue when displaying the media streams. Additionally, the media stream can be altered in real-time with smooth blending from one state to the next, interpolating from the present frame to the beginning of the first frame to be displayed. This also has the effect of immediately echoing the input to the player who altered them, yielding the all-important aspect of instant gratification.

Especially in the online fighting arena, playing information sequences simultaneously on both machines gives the defending player time to react, and moreover eliminates any charges of unfairness since both attacking and defending player see the same events unfold simultaneously. In addition, the synchronized data state eliminates the need for off-putting after the fact kludges to synchronize data states (i.e. getting shot through walls in Counterstrike) and allows for physics simulations since computers will not use different data for calculating collisions as they might using other latency-compensation schemes that require after-the-fact adjustment. Consequently, this networking solution is conducive to extremely complicated online physics interactions such as online ragdoll physics and is equally conducive to simpler applications such as real-time chat.

The solution of buffering the latency through transition information sequences also allows for solving another problem with telecommunications generally that has been around since the days of the telegraph. Namely, in situations where a broadcast is received by many people, the recipients of the telecommunication do not necessarily all receive the message simultaneously, because the latency from the signaling source is likely to be different for each one. This has never been regarded as a problem for broadcast media, because the difference is usually measured as a fraction of a second and the metrics for gauging the effectiveness of the message all hinge on the number of people who see the message eventually. Up until the present time, no one thought that the difference of a few thousand milliseconds made much difference and moreover, in the realm of traditional analog broadcasts, nothing could be done about it. However, where computers and the human subconscious are concerned, this can make a huge difference! (see getting shot through walls in Counterstrike).

### SUMMARY

This is a software method to synchronize the playback of media across a computer network where the latency from the signaling source is different for different machines on the network. The method consists of adding additional frames of information sequence to the front of a media stream after it is transmitted over the network in order to buffer the transmission latency. The number of frames is calculated for each computer in such a way as to synchronously deliver the media stream across the entire network as a shared experience across a distributed audience, allowing for a real-time online melee combat game/physics-based simulations (many-many) or broadcast media (one-to-many) such that a distributed audience perceives each frame of the media stream at the same instant.

### DESCRIPTION OF INVENTION

### Preferred Embodiment

This invention is a software method, consisting of at least one input device for controlling the media to output, a plurality of computing devices networked together via electronic means, at least one media source to display, as well as output devices such as a monitor and speakers, to name but one example. Software-wise, each computer contains a function to calculate one-way latency and the number of frames that represents, as well as functions to sending transition information sequences or transition frames to the media output devices in real-time, and functions to transmit to other computers on the network in real-time a signal for different main media clips to play. Each computer also has memory locations where the information sequences and frames to be played are stored, as well as smaller amounts of faster cached memory to buffer the calculated frames for quick and seamless display.

For applications where precalculation of datastreams is not plausible and as seamless a transition as possible is preferred, (i.e. online games) the preferred method of creating the Data Snippets is to dynamically-interpolate from the existing Data State when input is received to the first frame of the Datastream.
1) For many-to-many applications such as online gaming, the preferred embodiment is to store all the media sources on all the machines, so as to minimize the amount of data that needs to be transferred.
2) For broadcast media, the preferred embodiment is to have one media source to display connected to the same computer with the input device and that media source is streamed to a plurality of media display devices via the computers, where each instance of the media stream is buffered by a small, dedicated computer through which the stream must first pass en route to the output device that displays it. Each computer contains a video memory buffer sufficiently large to accommodate the necessary number of transition information sequence frames.

### Alternative Embodiment

It is possible to use pre-calculated transition information sequences instead of ones generated on the fly. This is good if you already know the one-way latency and are willing to precalculate every possible necessary transition information sequence. It saves the computational overhead of generating an interpolated frame at the expense of a smoother transition concerning latency. It is ideal for situations of non-interactive media where a broadcaster might want to use the transition frames as advertising, for example.

Preferred Operation

The first step is initialization. For this to happen, all computers with media display devices must measure the one-way latency from the computers with input devices attached where latency is a factor (excludes computers with both media output and input devices measuring internal latency). This should ideally happen periodically to account for the possibility that latency might change with respect to time. Alternatively, this can happen only once for applications where the latency is not going to change.

Upon measurement of the one-way latency, the computers calculate the length of time a transition clip must be displayed and the number of frames such a clip must be such that the sum of the length of time of the transition clip and the latency is some constant value. It must be longer than the highest latency. Failing that, all computers with higher latency must be dropped from the network or the constant amount of time must be increased for this technique to be effective.

Once the calculations are complete, at least one of the computers with an input device attached, such as a central server (although the existence of a central server is not in fact necessary), sends a signal to the other computers to begin media display as part of the initialization process in the case of many-to-many systems. All computers with input devices attached at this point then begin streaming the input state of the input device to all the other computers either directly or via a central server.

Using this method to synchronize media streams is simplicity itself. A human operator uses the input device to convey his wishes to play a particular media stream. This is transmitted to the computer the input device is attached to, which immediately sends the signal on to all the other computers on the network, either to each of several peers, or to a central server, which then sends it on to each of the clients.

The computer then causes the output device to sequentially display a number of transition frames, during which time, the input signal travels to and arrives at each computer on the network.

Upon arrival at each of the computers on the network, each computer calculates the number of transition frames it needs to display to fill the time interval of the total number of transition frames being displayed minus the one-way latency to the calculating computer. Each computer on the network makes this calculation as the input signal arrives and sequentially outputs the calculated number of frames.

The main information sequence is queued to start playing once the transition frames all finish playing. Because the transition frames finish playing at the same time, the main information sequence begins playing at the same time on all output devices and the audience's perception of said main information sequence is synchronized.

If a main information sequence is already playing when the operator uses the input device and enough frames are left in the main information sequence for the signal to reach all remote computers, transition frames are not displayed and the next main information sequence is simply queued for immediate display after the previous one.

Alternatively, in the case of one-to-many systems, such as for broadcast media, the initialization consists of streaming transmission of the media source to display to all the media display computers on the network, which use the technique to buffer the display of the stream while displaying transition frames, so as to synchronize its output to the display devices.

The transition frames ideally consist of an interpolation of the current media output state to the first frame of the main media clip to display in order to make a seamless transition.

The ultimate result is that the main information sequence clips and streams will maintain synchronization across a distributed audience with respect to time, with minimal amounts of controlled incongruity. The audience will therefore simultaneously and synchronously perceive the media clips, processing them synchronously, and psychologically united by their shared perception of the media stream.

As far as use of networking protocols currently in common use are concerned, UDP is likely to be a better choice than TCP/IP to minimize latency, except to confirm that a system is connected to the network and measure the latency.

Objects and Advantages:
(a) Local output device(s) immediately echo any input.
(b) Allows operator to dynamically change media clip in real-time.
(c) No off-putting after the fact adjustments. (e.g. getting shot through walls)
(d) Synchronistic display of data creates shared and synchronous experience and amongst audience members
(e) Synchronistic data state means complex calculations such as physics can be calculated in a deterministic manner on each remote computer while maintaining synchronicity.
(f) Allows online melee combat games to become a realistic option.
(g) Smooth interpolation of frame and data state in preferred embodiment eliminates “popping” and ensures transition is psychologically-acceptable to audience.
(h) Applicable to various old-line broadcast sources: Satellite, Cable, Radio, Online/Internet, Wireless, Digital Movie Theatres, Distributed Threading for Computing, etc.
(i) Many Potential Applications: Sports, News, Concerts, Emergency Broadcast System, 1st Run Movies, Financial Markets, Political Events, Pageants and Awards Ceremonies, Reality TV, Online Gaming, Physics Simulation, Training, Remote vehicle piloting, Tele-haptics, Tele-surgery, Tele-presence, Meta-verse, Virtual Recording Studio, Online Swordfighting etc.

Conclusion, Ramifications, and Scope of Invention

The reader will see that the latency is buffered by the fact that there are transition media clips and will also see that because the transition media clips play at different speeds and are timed precisely so that the main media clips begin playing at exactly the same time across a distributed network, a synchronous message can be perceived by an audience viewing innumerable different media output devices without respect to variable time or distance from source input.

In addition, by synchronizing the media clips and computerizing the process, complex interactions between the media clips can be consistently calculated independently and in real-time by the computers with the same results across the network. Thus, problems like physics are easily solved by the clients in a distributed system and there is no need to weigh down a server with the burden of transmitting the results of interactions that can now be processed in a distributed fashion and multi-threaded processes can be remotely distributed while being synchronously streamed and processed. Such a technique could even apply to the internal workings of multiprocessor systems as well by treating each processing unit as a computer connected to a network.

By staggering the transition information sequence lengths precisely, it is possible to get all media devices to play at the same time to a distributed audience. Before the range would be a few hundred milliseconds in the case of digital content, equivalent to several frames. The psychological implications of such a delay in synchronization to say, laughing at a joke, should be clear. The use of this technique can reduce the synchronization error across all devices on the network to within the tolerance of error that can be measured; usually a fraction of a frame. Cisco is supposed to possess a technique that can reduce the error in measuring this latency to less than 2 milliseconds.

Although initially intended to apply to online melee combat games such as fighting and action genres in the form of punch wind-up information sequences, other genres of online video game can also benefit. In football, a wide receiver takes a stutter-step, for example. Or in a racing game, the driver turns the wheel and the tires start squealing before the racecar itself turns. This is to demonstrate that there are numerous ways transition information sequences can be made psychologically-acceptable to online gamers, depending on the genre.

In addition, broadcasters should see the value as well.

Because the frames are displaying simultaneously, people in the audience will be interpreting them simultaneously. To the extent that a critical mass of audience members perceive the message embedded in the media stream simultaneously and their brains respond in similar ways, this generates network effects as the crowd forms a kind of collective unconscious, whereby resonantly increasing the psychological effectiveness of the media stream's embedded message.

By allowing a large audience to perceive an event synchronously, rather than merely transmitting a media stream simultaneously (and hence being at the mercy of differing amounts of latency), the audience generates a psychic field through its interpretation since the mental processes of the audience require use of their brains and the brain generates a kind of field that modern medical devices can measure. To the extent that this field resonates with the brainwaves of the audience members, the increase in its intensity in a broadcast using this system is proportionate to the reduction to elimination in phase-shift of brainwaves created by latency which exists using conventional means whereby the transmission is often synchronous but the interpretation is staggered across the audience by the range of differing latencies. The collective unconscious field should therefore be exponentially larger when a broadcast uses this methodology, meaning the audience shares an emotional and psychic experience that is completely in-phase and resonant.

Although one might argue that such an interpretation straddles the border between science and science fiction, there is actually ample empirical evidence that points to the phenomenon described in the preceding paragraph. There is scientific research, for example, such as that involving people in different rooms transmitting their thoughts to one another with greater frequency than mere chance would suggest according to an Artificial Life class I took at UCSD (COGS183 Summer II, 2001) and the Princeton PEAR program (http://www.princeton.edu/˜pear) which has discovered that human consciousness indeed has an effect on a quantum-seeded random number generator without regard to distance. According to their website, they have such an exhaustive volume of evidence that they have moved away from gathering evidence to disseminating their findings.

Moreover, additional experiments have demonstrated that this is not relevant to distance. And moreover, according to PEAR, the quantum phenomena precede the physical manifestation as we saw with the Indonesian tsunami. These findings have merely not yet widely disseminated to the lay-public.

There is, however, the evidence we see in our daily lives and can observe with our eyes. A live crowd, for example, can said to be a mob with all that implies. One may also say that there exists the concept of collective unconscious in the case of crowds, even though no physical contact may occur.

There are numerous cases where a collection of autonomous agents can be said to form a discrete entity such as when a group of human brain cells form a brain and other cases where this happens even when no physical contact occurs. In a far simpler case, there is ample evidence of this phenomenon in nature such as a flock of birds, a herd of stampeding cattle, a school of fish, or a swarm of insects. Although scientists like to invent descriptors such as chemicals and subtle ocean waves, they are merely projecting an explanation that confirms their own prejudices, rather than seeking the truth of the matter. In such cases, the synchronous and synchronistic behavior of a group of autonomous agents without physical contact behaving as a discrete entity must be due to collective unconscious on a deeper and subconscious level should rather be accepted as fact due to the sheer level of coordination required. Human mobs function much the same way. Although in the case of animals, this phenomenon is limited to movement (at least as far as we humans can tell), in the case of humans, this can have tremendous consequences, both positive and negative, such as crowds at music and sporting events creating a positive and festive atmosphere and negative effects such as panicked stampedes that end up killing people like when someone shouts “Fire!” in a crowded theater. Contemporary research has begun to delve into the “wisdom of crowds.”

The implications for commercial advertising are huge if this technology is exploited the right way through messages specifically designed to resonate with a mass audience. One may see that marketers today might sometimes prefer to reach a large audience simultaneously (e.g. the Superbowl) rather than a huge audience piecemeal such as running a commercial on a billboard over an extended period of time. This is especially true for those marketers targeting the mass rather than a niche market who hope to embed their message within popular consciousness to such an extent that it creates a kind of pop-culture phenomenon and people end up talking about it around the office water cooler on Monday morning. However, if marketers would truly realize the full potential of media, they must see to it that their audience's collective attention is simultaneously focused on the marketers' message so as to create a resonant effect that is more powerful than any individual's conscious will. This is especially true with those forms of entertainment where the level of interest and attention is greatest (in terms of intensity; not just raw numbers) and we see that it is sports and music with strong live followings where this is greatest. Broadcast media is not as gripping because the latency creates a phase difference in each audience member's brain and consequently, any collective unconscious is effectively garbled.

By substantially reducing or eliminating the phase difference in human brainwave activity of a large audience viewing a media event, the use of this technology will bring broadcast media, both passive and interactive, much closer to achieving the same effects as live events and would allow mixed media broadcasts to synchronously reach a global audience which would allow people in the entire world to respond subconsciously and synchronously to a marketer's message.

As more and more of the world goes online and can be reached via electronic media and in the Web 2.0 space, becomes active participants in the information and media sphere (China and India, despite being poor nations, have tremendous mobile phone and Internet penetration rates), more and more of the world will be potential users of this technology.

In the one-to-many space, marketers will see the advantage of being able to harness the collective brainpower of a large swathe of the entire planet, or at the very least, a critical mass of an extremely large market. The potential for a connected community to synchronously communicate with all members, without off-putting latency that erodes a truly shared experience, is something that cannot be ignored.

The reader will see that this technology will enable real-time psychologically-synchronized rich media (including 3D and physics) and for the first time, fully-enable web 3.0 communities to collaboratively communicate in cyberspace, in which it is possible for any number of human or computer operators to alter the media stream in real-time while a robust computer system reconciles all the different directions the audience attempts to push the media stream in real-time, opening up previously impossible new avenues for distributed real-time collaboration.

The possibilities for synchronizing the output of information streams are innumerable as synchronizing the information streams and being able to alter them in real-time such that the overall system remains seamlessly synchronized and unperturbed to any observer and being able to assimilate any amounts of new information through this method and synchronously output it across the entire network means a wealth of applications for any industry which depend on the coordination of large groups of people or computers such as multinationals with distributed operations, the military, synchronization of financial services data to control arbitrage situations, mass-marketing for broadcast advertisers, online gaming, training, and research.

To put it in a nutshell, any activity that requires remotely coordinating large groups of either people or systems will benefit immensely from this invention in terms of the level of coordination achieved.

Glossary:
Media: Information intended to be processed sequentially by either a human or computer.
Digital Media: Media encoded and transmitted as a series of small pulses of energy
Information Sequence: A sequence of information stored as a series of frames and output sequentially
Frame: Digital Media corresponding to a particular time index and displayed for a certain length of time.
Latency: Difference in time between when information is transmitted and when it is received
Play: When the media is output to various devices such as speakers and monitors

What is claimed is:

1. A method for dynamically synchronizing data communications among multiple output devices on a computer network where latency is an issue, comprising,
(a) identifying the latency between all devices on the computer network,
(b) storing on each receiving device the latency values between said receiving device and all other devices on said network
(c) triggering of a series of operations on each receiving device on said network when data for display or an instruction to display previously stored data is received from a sending device on said network, performed in this order:
(1) retrieving from storage the latency value associated with said sending device
(2) using said latency value to calculate the delay period to occur before said data is displayed by said receiving machine, said delay period being such as to ensure simultaneous display of said data on all devices on said network that received said data or an instruction to display data
(3) calculating the number of transition frames to be displayed during said calculated delay period
whereby the calculation of said delay period and display of said transition frames for the duration of said delay period preceding display of said data ensures that display of data commences at the same time throughout said network on all devices to which said data or an instruction to display data was sent.
